(19) United States
(12) Patent Application Publication
(10) Pub. No.: US 2014/0293047 A1
(43) Pub. Date: Oct. 2, 2014

(54) SYSTEM FOR GENERATING OVERHEAD VIEW OF MACHINE

(71) Applicant: CATERPILLAR INC., Peoria, IL (US)

(72) Inventor: Daniel D. Morris, Pittsburgh, PA (US)

(73) Assignee: Caterpillar Inc., Peoria, IL (US)

(21) Appl. No.: 13/855,389

(22) Filed: Apr. 2, 2013

(51) Int. Cl. B60R 1/00

(52) U.S. Cl. CPC B60R 1/002
USPC 348/143

(57) ABSTRACT

A system for providing an overhead view of a machine including a desired target position is disclosed. The system includes an off-board camera device configured to capture a top-down camera view of a worksite. The system further includes a system controller configured to receive data corresponding to the desired target position and a top down camera view of the worksite including the desired target position. The system controller also receives a data corresponding to position of the machine at the worksite. The system controller further provides the overhead view of the machine including the desired target position to a display within a cab of the machine. The system controller provides the overhead view of the machine when the machine is within a predetermined range at the worksite relative to the desired target position.

### TECHNICAL FIELD

The present disclosure relates to a system for providing a display of an overhead camera view of a machine to an operator, and more particularly to providing a display of an overhead view of the machine at a worksite including a desired target position.

### BACKGROUND

On-board camera vision systems have been used to provide a display to a machine operator that includes one or more views of the machine for greater visibility and control. For example, a camera vision system may include a number of on-board cameras to generate an overhead view of the machine and its surroundings.

PCT application 2012/003945 relates to a method for detecting and displaying regions located laterally adjacent and laterally behind a vehicle. According to the method, images of the regions are detected by a plurality of image-detecting units and are output by means of display units assigned to the image-detecting units. The output of the detected images is adapted dynamically in dependence upon an actual driving situation and/or user input.

### SUMMARY OF THE DISCLOSURE

In one aspect of the present disclosure a system for providing an overhead view of a machine including a desired target position is provided. The system includes an off-board camera device configured to capture a top-down camera view of a worksite. The system further includes a system controller configured to receive data corresponding to the desired target position receive a top-down camera view of the worksite including the desired target position. The system controller also receives data corresponding to position of the machine at the worksite. The system controller further provides the overhead view of the machine including the desired target position to a display within a cab of the machine, when the machine is within a predetermined range at the worksite relative to the desired target position.

In another aspect of the present disclosure a method for providing the overhead view of the machine including the desired target position is provided. The method includes determining the desired target position and receiving the top-down camera view of the worksite including the desired target position using the off-board camera device. The method further includes determining the position of the machine and providing the overhead view of the machine including the desired target position to a display within the cab of the machine, when the machine is within a predetermined range at the worksite relative to the desired target position.

In a yet another aspect of the present disclosure a system for providing an overhead view of a machine including a desired target position is provided. The system includes an off-board camera device configured to capture a top-down camera view of a worksite. The system further includes a system controller configured to receive data corresponding to the desired target position receive a top-down camera view of the worksite including the desired target position. The system controller also receives data corresponding to position of the machine at the worksite. The system controller further transforms the top down camera view of the worksite including the desired target position based on the position and/or orientation of the machine at the worksite to provide the overhead view of the machine including the desired target position to a display within a cab of the machine.

Other features and aspects of this disclosure will be apparent from the following description and the accompanying drawings.

### BRIEF DESCRIPTION OF THE DRAWINGS

FIG. 1 illustrates an exemplary worksite including a machine, according to an embodiment of the present disclosure;

FIG. 2 illustrates an exemplary system of generating an overhead view of the machine of FIG. 1; and

FIG. 3 illustrates an exemplary method of generating an overhead view of the machine.

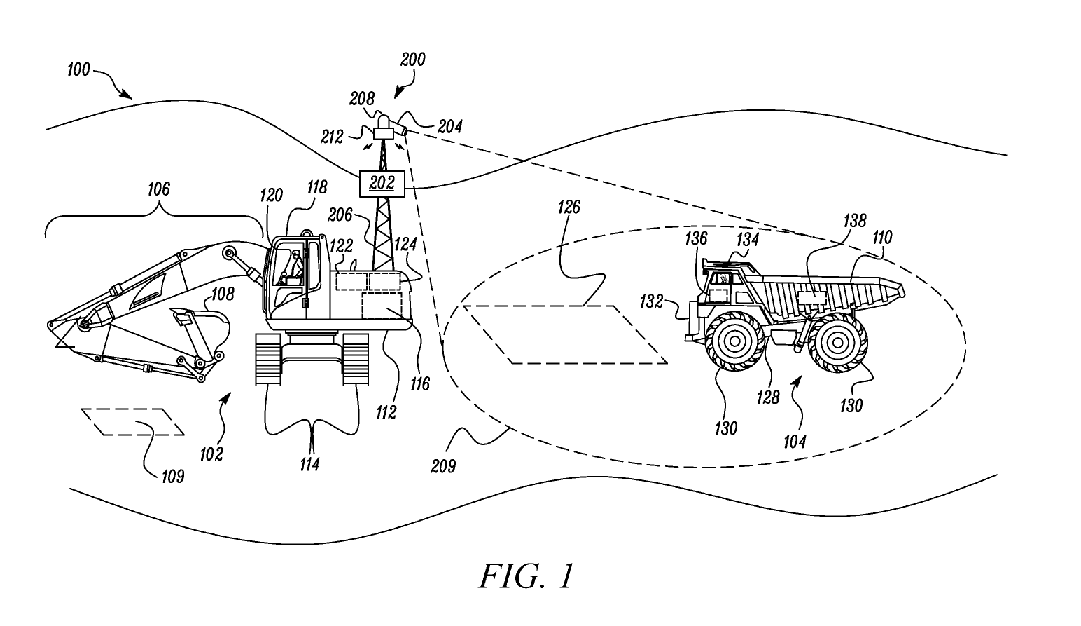

### DETAILED DESCRIPTION

Wherever possible, the same reference numbers will be used throughout the drawings to refer to the same or the like parts. The present disclosure relates to a system for providing an overhead view of a machine at a worksite. FIG. 1 illustrates an exemplary worksite 100 employing one or more machines, such as, a first machine 102, and a second machine 104 operating thereon. The first machine 102 may be configured to excavate and load material onto the second machine 104. In an aspect of the present disclosure, the first machine 102 may be embodied as a hydraulic excavator. However, in various other embodiments, the first machine 102 may be any excavation and/or material handling machine, such as a backhoe loader, a front shovel, a dragline excavator, or the like. The first machine 102 may include an implement system 106 configured to move an implement 108, such as a bucket, to excavate and load material from a dig position 109 onto a payload carrier 110 of the second machine 104.

As shown in FIG. 1, the first machine 102 may further include a frame 112, a drive system 114 for propelling the first machine 102, a power source 116 that provides power to the implement system 106 and the drive system 114, and an operator station 118 to control the implement system 106 and the drive systems 114. The operator station 118 includes one or more operator input devices 120 configured to receive and/or transmit various inputs indicative of an operator desired movement of the implement 108 and/or the first machine 102. The operator input devices 120 may include a steering wheel, knobs, push-pull devices, switches, pedals, levers, joysticks, touch screens, displays and any other operator input devices well-known in the art. Although, the operator station 118 is depicted to be on-board the first machine 102, it will be understood that, in another embodiment, the operator station 118 may be located at a remote location for remote control of the first machine 102. Further, the first machine 102 may include one or more sensors (not shown) to detect a number of physical characteristics associated with the first machine 102. For example, the physical characteristics may include a position of the implement 108, a first machine swing angle, etc.

The first machine 102 may further include a machine controller, such as a first machine controller 122 and a first positioning system 124. The first machine controller 122 is communicably coupled to the operator input devices 120 and the one or more sensors to receive signals indicative of the desired movement of the implement 108, the position of the implement 108, and the first machine swing angle. Further, the first positioning system 124 is configured to detect a position of the first machine 102 at the worksite 100. In an embodiment, the position of the first machine 102 may be indicative of location co-ordinates of the first machine 102 at the worksite 100. The first positioning system 124 is communicably coupled to the first machine controller 122 and configured to transmit a signal indicative of the position of the first machine 102. According to an embodiment, the first machine controller 122 is configured to determine a desired target position 126 at the worksite 100. As illustrated, the desired target position 126 may be indicative of a set of location co-ordinates defining a loading site for the second machine 104 in vicinity of the first machine 102. Alternatively, the desired target position 126 may be a parking site, a maintenance site, or a refueling site for the first machine 102 and/or the second machine 104 at the worksite 100.

In an aspect of the present disclosure, the second machine 104 may be embodied as a haul truck. The second machine 104 may be used to transport the material like sand, gravel, stones, soil, excavated material, and the like from one location to another location at the worksite 100 or outside the worksite 100. Further, the second machine 104 may include a frame 128, wheels 130, and an engine compartment 132 supported on the frame 128. The second machine 104 may further include an engine (not shown) disposed within the engine compartment 132. The engine may be an internal combustion engine, a hybrid engine, a non-conventional power source like batteries, or any other power source known in the art. The second machine 104 may further include a cab 134 mounted on the frame 128. The cab 134 may also include operator input devices (not shown) to control the movement and the operation of the second machine 104.

The second machine 104 may include a machine controller, such as a second machine controller 136 and a second positioning system 138. The second machine controller 136 is communicably coupled to the operator input devices of the second machine 104 to receive signals indicative of the movement and/or operation of the second machine 104. Further, the second positioning system 138 is configured to detect a position of the second machine 104 at the worksite 100. In an embodiment, the position of the second machine 104 may be indicative of location co-ordinates of the second machine 104 at the worksite 100. The second positioning system 138 is communicably coupled to the second machine controller 136 and configured to transmit a signal indicative of the position of the second machine 104. It will be apparent to a person having ordinary skill in the art that the first and second positioning systems 124, 138 may be a Global Navigation Satellite System, a Global Positioning System, any other Satellite Navigation System, an Inertial Navigation System, an Augmented Navigation System, any other known positioning system, or a combination thereof.

According to an aspect of the present disclosure, a system 200 is provided to generate an overhead view of the machines, such as the second machine 104 at the worksite 100 including the desired target position 126. The overhead view may be an elevated view of the second machine 104 from above, with a top-down perspective, for example a bird's-eye view. The system 200 may include a system controller 202 and an off-board camera device 204 positioned off-board the second machine 104. The system controller 202 is communicably coupled to the first machine controller 122 and configured to receive data corresponding to the desired target position 126 at the worksite 100. Further, the system controller 202 is communicably coupled to the second machine controller 136 and configured to receive data corresponding to the position of the second machine 104 at the worksite 100. In an embodiment, the system controller 202 may be on-board the first machine 102. In another embodiment, the system controller 202 may be on-board the second machine 104. In yet another embodiment, the system controller 202 may be located at the remote location at the worksite 100 such as an off-board remote command station.

According to an aspect of the present disclosure, the camera device 204 may be positioned at an elevated position with respect to the first and the second machines 102, 104, such as on a tower 206, in proximity of the desired target position 126. In one embodiment, the tower 206 may be fixed on the frame 112 of the first machine 102. In an alternative embodiment, the tower 206 may be fixed on a ground level at the worksite 100, or mounted on a movable cart or trailer. Although only one camera device 204 is shown in FIG. 1, it may be understood that more than one camera devices may be positioned at the worksite 100. The camera device 204 may be configured to capture a top-down camera view of the worksite 100. In an embodiment, the camera device 204 may include an adjusting mechanism 208 configured to rotate, adjust elevation of the camera device 204. Examples of the camera device 204 may include a still camera for capturing images, or a video camera for capturing video feeds. The camera device 204 may be a solar powered worksite camera device with night vision and cellular connectivity capabilities well-known in the art. The camera device 204 may include one or more sensors 212 communicably coupled to the system controller 202 to provide data corresponding to a current position of the camera device 204

According to an aspect of the present disclosure, the camera device 204 is communicably coupled to the system controller 202 and configured to rotate and/or adjust elevation, using the adjusting mechanism 208, and capture the top-down camera view of the worksite 100 including the desired target position 126. In an embodiment, the top-down camera view of the worksite 100 including the desired target position 126 may be defined as a virtual boundary 209 around the desired target position 126 at the worksite 100. In an alternative embodiment, the boundary 209 may be any pre-determined range at the worksite 100 relative to the desired target position 126. In a yet another embodiment, the boundary 209 may be based on a distance of the second machine 104 from the target position 126. In an embodiment, the boundary 209 may be defined by the operator of the first machine 102. Further, the camera device 204 is configured to transmit the captured top-down camera view of the worksite 100 including the desired target position 126 to the system controller 202. The system controller 202 is configured to provide the overhead view of the second machine 104 at the worksite 100 including the desired target position 126 based on the top-down camera view and the position of the second machine 104 at the worksite 100.

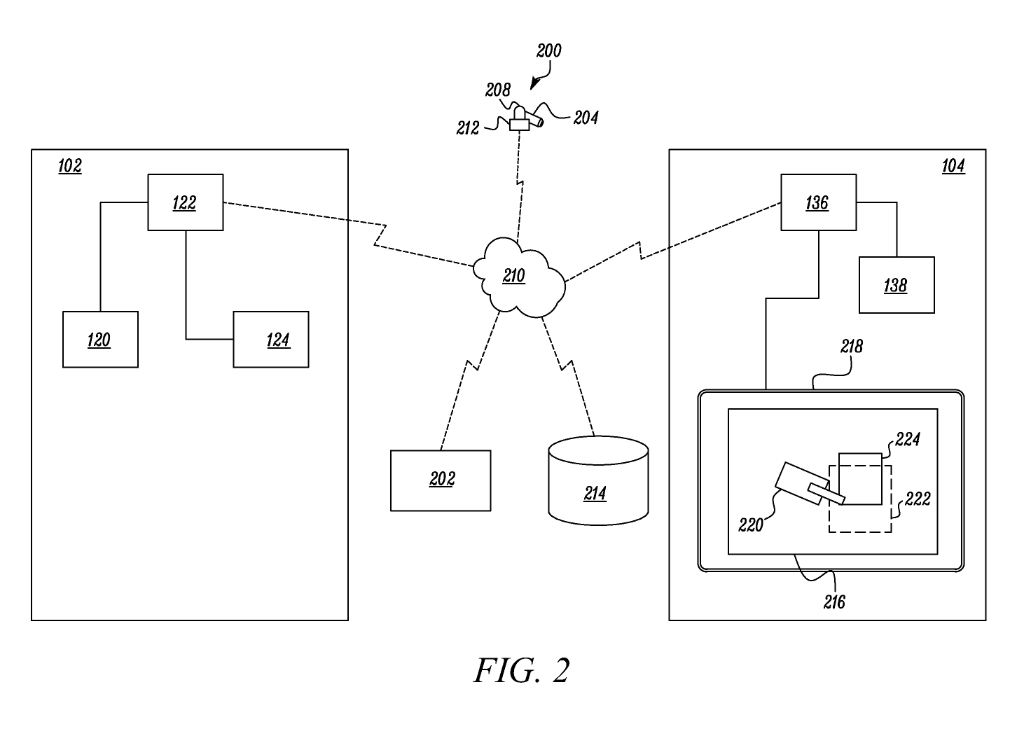

FIG. 2 illustrates a block diagram of the system 200 for providing the overhead view of the second machine 104 at the worksite 100 including the desired target position 126. As illustrated, the system controller 202 is configured to communicate with the first machine controller 122, the second machine controller 136, and the camera device 204 via a communication network 210. The communication network 210 may be implemented as a wired network, a wireless network or a combination thereof. The communication network 210 may be, but not limited to, a wide area network (WAN), a local area network (LAN), an Ethernet, Internet, an Intranet, a cellular network, a satellite network, or any other suitable network for providing communication between the system controller 202 and the first machine controller 122, the second machine controller 136, and the camera device 204.

In an exemplary embodiment, the first machine controller 122 is configured to determine a set of target positions at the worksite 100, based on at least one of the position of the first machine 102 at the worksite 100, the position of the implement 108, and the first machine swing angle. Further, the first machine controller 122 may provide the set of target positions to the operator for selection using the operator input devices 120 such as on the display. In another embodiment, the first machine controller 122 may be configured to receive the input indicative of the desired target position 126 directly from the operator as a manual input using the operator interface devices 120 such as the touch screen display that displays the worksite 100. Furthermore, the system controller 202 is configured to receive the data corresponding to the desired target position 126 from the first machine controller 122.

The one or more sensors 212 of the camera device 204 may be configured to provide data corresponding to a current position of the camera device 204 to the system controller 202. The system controller 202 may be configured to activate the adjusting mechanism 208 to adjust the position of the camera device 204 based on the current position of the camera device 204, the position of the desired target position 126 and the machine swing angle of the first machine 102 to capture the top-down camera view of the worksite 100 including the desired target position 126. For example, the desired target position 126 is on the right hand side of the first machine 102 and the camera device 204 is positioned to face the left hand side of the first machine 102, then the system controller 202 may be configured to rotate and adjust the camera device 204 to face the right hand side of the first machine 102 to capture the top-down camera view of the worksite 100 including the desired target position 126. Moreover, the camera device 204 may also be adjusted based on the movement of the frame 112 of the first machine 102. In another embodiment, the system controller 202 may be configured to select the camera device 204 from a set of multiple camera devices to capture the top-down camera view of the worksite 100 including the desired target position 126. In yet another embodiment, system controller 202 may be configured to receive an input from the operator of the first machine 102 to adjust and/or select the camera device 204. Although, only one camera device 204 is described herein to capture the top-down camera view of the worksite 100 including the desired target position 126, it will be understood that there may be more than one camera devices that, in combination with each other, capture the top-down camera view of the worksite 100 including the desired target position 126.

The camera device 204 may be configured to transmit the top-down camera view of the worksite 100 including the desired target position 126 to the system controller 202 via the communication network 210. In an embodiment, the system controller 202 is configured to establish communication, via the communication network 210, with the second machine controller 136 of the second machine 104 operating within the boundary 209. In one embodiment, one or more tracking systems may be provided to detect the second machine 104 within the boundary 209 such that signals from these tracking systems, indicative of the second machine 104 within the boundary 209, may be communicated to the system controller 202. Examples of the tracking systems may include RFID systems, Tripwires, or any other tracking system well known in the art. In an alternative embodiment, the position of the second machine 104 at the worksite 100 may be used to determine if the second machine 104 is operating within the boundary 209. Further, the second positioning system 130 associated with the second machine 104 provides the real time position information of the second machine 104 to the system controller 202.

Further, the system 200 may include a database 214 communicably coupled to the system controller 202 via the communication network 210. The database 214 may store and update data related to a site map, site terrain, and/or data relating to other machines employed at the worksite 100. Further, the database 214 may also store location co-ordinates of the first machine 102, the second machine 104, and the desired target position 126. Moreover, the database 214 may be capable of storing and/or modifying the pre-stored data as per operational and design needs. In one embodiment, the database 214 may be external to the first machine 102 and/or the second machine 104 and located at the remote location. In a yet another embodiment, the database 214 may be internally placed within the first machine 102 and/or the second machine 104. The system controller 202 is configured to retrieve the data associated with the worksite 100 from the database 214 to determine the position and orientation of the first machine 102, the second machine 104, and the camera device 204 at the worksite 100.

According to an embodiment, the system controller 202 may be configured to generate an intermediate image indicative of the position and orientation of the second machine 104 within the top-down camera view of the worksite 100 including the desired target position 126. In an exemplary embodiment, the system controller 202 is configured to perform background subtraction to detect the position and orientation of the second machine 104 and the desired target position 126 in the top-down camera view of the worksite 100 including the desired target position 126. For the purposes of explanation, background subtraction is a technique for extracting foreground objects of importance in an image, in this case, the position and orientation of the first and second machines 102, 104 and the desired target position 126. In an alternate embodiment, the system controller 202 may perform any other foreground object extraction technique, such as image segmentation to indicate the position of the second machine 104 in the top-down camera view of the desired target position 126. Further, when the position and orientation of the second machine 104 is detected in the intermediate image, the system controller 202 may use image processing techniques, such as edge modeling to track the second machine 104 and locate the real time position and orientation of the second machine 104 within the top-down camera view, as it approaches the desired target position 126.

Furthermore, the system controller 202 is configured to provide the overhead view of the second machine 104 including the desired target position 126. In an embodiment, system controller 202 transforms the top-down camera view using image-processing techniques such as image rotation, scaling and cropping into the overhead view of the second machine 104. The overhead view of the second machine 104 may include the second machine 104 and its position and orientation as it moves closer to the desired target position 126. Alternately, the system controller 202 may generate an overhead view from the perspective of the desired target position 126 using the intermediate image of the top-down camera view of the desired target position 126. This means, that the overhead view from the perspective of the desired target position 126 may include the position of the desired target position 126 as the primary object while it moves closer to the second machine 104.

Further, the system controller 202 may be configured to generate an annotated view 216 based on the overhead view of the second machine 104 including the desired target position 126. Furthermore, the system controller 202 may be configured to transmit the annotated view 216 to a display device 218 of the second machine 104 via the second machine controller 136. The annotated view 216 may include one or more annotations superimposed on the position of the first machine 102, the second machine 104, and the desired target position 126 at the worksite 100. Examples of annotations may also include highlights, outlines, etc., indicating the position of the implement system 106, implement 108, and the camera device 204. As illustrated in the figure, the annotated view 216 may include an annotation 220 of the first machine 102, an annotation 222 of the desired target position 126, and an annotation 224 of the second machine 104. In an embodiment, in the annotated view 216 the annotation 224 of the second machine 104 a front end of the second machine 104, such as the cab 134, faces towards a top side of the display device 218. Moreover, the annotation 224 of the second machine 104 is positioned substantially at the center of the display device 218. The system controller 202 is configured to transform the top-down camera view to rotate the top down view as per the annotation 224 of the second machine 104 wherein the front end of the second machine 104 is facing towards the top side of the display device 218.

The display device 218 is configured to display the annotated view 210 to the operator of the second machine 104. In an embodiment of the present disclosure, the second machine controller 136 may be configured to provide a list of views that may be displayed on the display device 218 of the second machine 104. In an exemplary embodiment, the operator of the second machine 104 may select to view the generated overhead view of the second machine 104 at the worksite 100 including the desired target position 126. In another embodiment, the operator may select to view the annotated view 216 of the overhead view of the second machine 104 at the worksite 100 including the desired target position 126. In a yet another embodiment, the operator may select to view either a video based annotation or a still image based annotation of the overhead view of the second machine 104 including the desired target position 126.

Although, the description is with reference to the implementation of the system 200 partially on each of the first machine 102 and the second machine 104 where the system controller 202 communicates over the communication network 210 with the first machine 102 and second machine 104, it will be understood that the system 200 may be implemented completely on either the first machine 102, or the second machine 104 or the off-board remote command station at the worksite 100. Furthermore, the first machine 102 and the second machine 104 are merely exemplary and hence non-limiting of this disclosure. The system 200 may be implemented at the worksite 100 and for any machine that requires to reach a desired target position at the worksite 100.

### INDUSTRIAL APPLICABILITY

On-board camera vision systems are generally used to assist an operator of a machine, such as a haul truck, at a worksite. These on-board camera vision systems generate and use an overhead view of the machine and its surroundings to assist the operator of the machine to reach a desired target position for material loading. Typically, these camera vision systems include a number of on-board cameras of the machine to generate the overhead view and its surroundings. Generally, these on-board cameras based vision systems are expensive to implement.

According to the present disclosure, system 200 for generating the overhead view of the second machine 104 utilizes one or more elevated camera devices, i.e., the camera device 204. This system 200 requires camera devices 204 to be installed only in proximity of the desired target position 126. Therefore, this reduces the cost of installation and is less complex. In an exemplary embodiment, the on-board controller 136 of the second machine 104 may assist the operator in navigating from a current position to the desired target position 126, using the annotated view 216. The second machine 104 may be configured to include additional output devices, such as audio output device, additional display devices configured to provide instructions for direction of movement of the second machine 104 to reach the desired target position 126. In a further embodiment, the operator of the second machine 104 may select the form of navigation instructions to be received. For example, the instructions may be in the form of an audio signal, visual signal, or text.

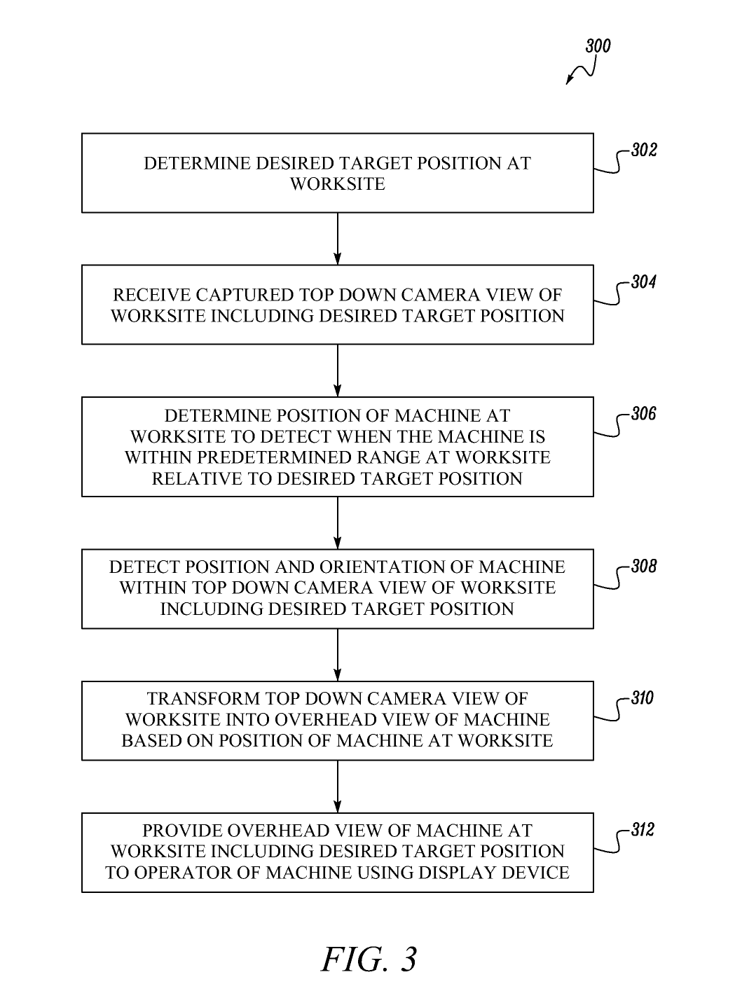

FIG. 3 illustrates a method 300 for providing the overhead view of the second machine 104 including the desired target position 126. At step 302, the desired target position 126 at the worksite 100 may be determined. For example, the first machine controller 122 may determine the desired target position 126 based on at least one of the position of the first machine 102 at the worksite 100, the position of the implement 108, and the machine swing angle. Alternatively, the operator of the first machine 102 may input a desired target position 126, for example by using a touch screen display within the operator station 118 of the first machine 102 that displays the worksite 100.

Further, at step 304, captured top down camera view of the worksite 100 may be received. In an embodiment, the system controller 202 may be configured to receive the captured top-down camera view of the worksite 100 including the desired target position 126 in the form of image data from the off-board camera device 204 positioned at an elevated position either on the first machine 102 or positioned at the worksite 100. In an aspect of the present disclosure, the position of the camera device 204 may be adjusted based on desired target position 126, the position of the first machine 102 and the machine swing angle of the first machine 102, to capture the top-down camera view of the worksite 100 including the desired target position 126. For example, the system controller 202 may be configured to rotate and/or adjust elevation to of the camera device 204 to capture the top-down camera view of the worksite 100 using the adjusting mechanism 208. In an alternative embodiment, a desired one or more camera device 204 from a set of camera devices positioned on the first machine 102 and/or the worksite 100 may be selected to capture the worksite 100 including the desired target position 126.

Further, at step 306, the position of the machine, such as the second machine 104 may be determined. The position of the second machine 104 may then be used to determine when to provide the overhead view of the second machine 104 to the operator of the second machine 102 using the display 218 of the second machine 104. For example, the system controller 202 may communicate with the second machine controller 136 when the second machine 104 is operating within the boundary 209. In an alternative embodiment, a tracking system may be provided on the worksite to determine when the second machine 104 is operating within the boundary 209. Examples of the tracking system may include an RFID system, or a tripwire etc. Therefore, the system controller 202 may provide the overhead view of the second machine 104 when it is detected within the boundary 209.

Furthermore, at step 308, position of the machine, such as the second machine 104 may be detected within the top-down camera view of the worksite 10 including the desired target position 126. In an embodiment, the system controller 202 may generate the intermediate image indicative of the position of the second machine 104 within the top-down camera view of the worksite 100 including the desired target position 126. For example, the system controller 202 may use background subtraction or any other foreground object extraction technique to extract the position and orientation of the second machine 104 in the top-down camera view of the worksite 100. Further, image processing techniques, such as edge modeling may be used to track the second machine 104 and locate the real time position and orientation of the second machine 104 within the intermediate image, as it approaches towards the desired target position 126.

Further, at step 310 the top down camera view of the worksite 100 may be transformed to generate the overhead view from the perspective of the second machine 104 based on the position and orientation of the second machine 102 at the worksite 100. This means, that the overhead view of the second machine 104 may include the second machine 104 and its position as the primary object while it moves closer to the desired target position 126. In one embodiment, the image-processing techniques such as image rotation, scaling and cropping may be used to transform the intermediate image into the overhead view from the perspective of the second machine 104. Alternatively, the overhead view from the perspective of the desired target position 126 may be generated using the intermediate image. This means, that the overhead view from the perspective of the desired target position 126 may include the desired target position 126 as the primary object while it moves closer to the second machine 104.

At step 312, the generated overhead view of the second machine 104 including the desired target position 126 is provided to the operator in the cab 134 of the second machine 104 using the display 218. In an embodiment, an annotated view 216 of the generated overhead view of the second machine 104 including the desired target position 126 may be provided to the operator of the second machine 104 using the display device 218. For example, the system controller 202 may generate the annotated view 216 of the overhead view of the second machine 104 at the worksite 100 including the desired target position 126. Examples of annotations may include highlights, outlines, and text etc., superimposed on the position of the first machine 102, the second machine 104, and the desired target position 126 at the worksite 100. Furthermore, the annotated view 216 may be communicated to the display device 218 of the second machine 104. In an aspect of the present disclosure, the annotated view 216 may include an annotation 220 of the position of the first machine 102, an annotation 222 of the position of the desired target position 126 and an annotation 224 of the position of the second machine 104 at the worksite 100.

As will be understood by a person skilled in the art, the annotated view 216 may enable the operator of the second machine 104 to be assisted in moving the second machine 104 to the desired target position 126. The second machine 104 may be configured to include additional output devices, such as audio output device, additional display devices configured to provide instructions for direction of movement of the machine 104 to reach the desired target position 126. For example, the instructions may be in the form of an audio signal, visual signal, or text.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for providing an overhead view of a machine including a desired target position, the system comprising:
an off-board camera device configured to capture a top-down camera view of a worksite; and
a system controller configured to:
receive data corresponding to the desired target position at the worksite;
receive a top down camera view of the worksite including the desired target position;
receive data corresponding to a position of the machine at the worksite; and
provide the overhead view of the machine including the desired target position to a display within a cab of the machine, wherein the overhead view of the machine is provided when the machine is within a predetermined range at the worksite relative to the desired target position.

2. The system of claim 1, wherein the off-board camera device is positioned at an elevated position with respect to the machine in proximity of the desired target position.

3. The system of claim 1, wherein the system controller is further configured to adjust the off-board camera device based on the received data corresponding to the desired target position at the worksite to capture the top-down camera view of the worksite including the desired target position.

4. The system of claim 1, wherein the system controller is configured to select at least one off-board camera device from a set of off-board camera devices positioned at the worksite to capture the top-down camera view of the worksite including the desired target position.

5. The system of claim 1, wherein the system controller is further configured to generate an intermediate image indicative of the position and orientation of the machine within the top-down camera view of the worksite including the desired target position.

6. The system of claim 1, wherein the system controller is further configured to transform the top-down camera view based on the position and the orientation of the machine at the worksite to generate the overhead view of the machine including the desired target position.

7. The system of claim 1, wherein the system controller is further configured to generate an annotated view based on the overhead view of the machine including the desired target position.

8. The system of claim 7, wherein the system controller is configured to transform the top-down camera view to rotate the top down view as per an annotation of the machine in the annotated view, wherein in the annotated view a front end of the machine is facing towards a top side of a display device.

9. The system of claim 1, wherein the predetermined range at the worksite is based on the top down camera view of the worksite.

10. The system of claim 1, wherein the predetermined range is based on a distance between the machine and the target position.

11. A method for providing an overhead view of a machine including a desired target position, the method comprising:
determining the desired target position at a worksite;
receiving a top-down camera view of the worksite including the desired target position using an off-board camera device;
determining a position of the machine at the worksite; and
providing the overhead view of the machine including the desired target position to a display within a cab of the machine, wherein the overhead view of the machine is provided when the machine is within a predetermined range at the worksite relative to the desired target position.

12. The method of claim 11, wherein receiving the top-down camera view of the worksite including the desired target position comprises adjusting the off-board camera device based on the determined desired target position at the worksite.

13. The method of claim 11, wherein receiving the top-down camera view of the worksite including the desired target position comprises selecting at least one off-board camera device from a set of off-board camera devices positioned at the worksite to capture the top-down camera view of the worksite including the desired target position.

14. The method of claim 11, wherein providing the overhead view of the machine at the worksite including the desired target position comprises generating an intermediate image indicative of the position and orientation of the machine within the top-down camera view of the worksite including the target position.

15. The method of claim 11, wherein providing the overhead view of the machine at the worksite including the desired target position comprises transforming the top-down camera view based on the position and the orientation of the machine at the worksite to generate the overhead view of the machine including the desired target position.

16. The method of claim 11, wherein providing the overhead view of the machine including the desired target position comprises generating an annotated view based on the overhead view of the machine including the desired target position.

17. A system for providing an overhead view of a machine including a desired target position, the system comprising:
an off-board camera device configured to capture a top-down camera view of the worksite; and
a system controller configured to:
receive data corresponding to the desired target position at the worksite;
receive a top down camera view of the worksite including the desired target position;
receive data corresponding to a position of the machine at the worksite; and
transform the top down camera view based on the position of the machine at the worksite to provide the overhead view of the machine including the desired target position to a display within a cab of the machine.

18. The system of claim 17, wherein the off-board camera device is positioned at an elevated position with respect to the machine in proximity of the desired target position

19. The system of claim 17, wherein the overhead view of the machine including the desired target position is provided when the machine is within a desired predetermined range at the worksite relative to the desired target position.

20. The system of claim 19, wherein the predetermined range at the worksite is based on the top down camera view of the worksite.
